(19) United States
(12) Patent Application Publication
(10) Pub. No.: US 2018/0004114 A1
(43) Pub. Date: Jan. 4, 2018

(54) IMAGE FORMING APPARATUS

(71) Applicant: CANON KABUSHIKI KAISHA, Tokyo (JP)

(72) Inventor: Yukio Nagaya, Toride-shi (JP)

(21) Appl. No.: 15/630,974

(22) Filed: Jun. 23, 2017

(30) Foreign Application Priority Data
Jun. 29, 2016 (JP) 2016-129078

(51) Int. Cl. G03G 15/04; G03G 21/16; G06K 15/12; G03G 15/043

(52) U.S. Cl. CPC G03G 15/04; G06K 15/12; G03G 21/16; G03G 15/043

(57) ABSTRACT

An image forming apparatus includes an image forming portion, a detecting portion capable of detecting a light transmittance of the sheet before image formation; and a controller configured to set an initial value of the light transmittance of the sheet before the image formation detected by the detecting portion. When a change amount, from the initial value, of a light transmittance detected after setting of the initial value satisfies a predetermined condition, the controller is capable of executing an operation in a condition changing mode for changing an image forming condition of said image forming portion.

### FIELD OF THE INVENTION AND RELATED ART

The present invention relates to an image forming apparatus of an electrophotographic type, an electrostatic recording type or the like, in which an image is formed on a recording material such as paper.

Conventionally, the image forming apparatus of the electrophotographic type has been widely used as a copying machine, a printer, a plotter, a facsimile machine, a multi-function machine having a plurality of functions of these machines, or the like. In the image forming apparatus of this type, electrically charged toner is caused to approach an image bearing member in a developing device and is electrostatically deposited on an electrostatic latent image on the image bearing member, whereby development is carried out and an image is formed. In an image forming step, depending on a kind and a basis weight (weight per unit area) of the recording material (hereinafter, also referred to as a sheet), a condition, such as a transfer condition or a fixing condition, suitable for image formation changes. As disclosed in Japanese Laid-Open Patent Application (JP-A) 2007-55814, in advance of image formation, the kind and the basis weight of the sheet are discriminated, and depending on a result of the discrimination, an image forming condition is controlled. Such an image forming apparatus has been known.

This image forming apparatus includes a state detecting portion including an LED, for reflected light, capable of irradiating the sheet with the reflected light, an LED, for transmitted light, capable of irradiating the sheet with the transmitted light, and a light receiving portion capable of receiving the reflected light or the transmitted light. This state detecting portion is capable of detecting smoothness of the sheet surface by detecting the reflected light through the light receiving portion. Further, the state detecting portion detects a transmitted light quantity or a transmittance by detecting the transmitted light through the light receiving portion, and on the basis of the detected transmitted light quantity or the detected transmittance, the state detecting portion is capable of detecting the basis weight of the sheet. Further, the state detecting portion is capable of detecting a kind of the sheet from the smoothness of the sheet surface and the basis weight of the surface. The image forming apparatus controls an image forming condition, such as a transfer condition or a fixing condition, on the basis of the detected kind of the sheet.

However, in the image forming apparatus disclosed in JP-A 2007-55814, it is possible to detect the kind and the basis weight of the sheet to be subjected to image formation, but detection of a water-retaining state of the sheet was not taken into consideration. Depending on an installation environment and a status of use of the image forming apparatus, moisture absorption and drying of the sheet accommodated in a sheet feeding portion progresses in some instances, and in that case, in the above-described image forming apparatus, there was a liability that the image forming condition cannot be satisfactorily controlled. As a result, for example, there were liabilities that the sheet was in an excessive moisture absorption state and thus caused improper feeding thereof due to carl or the like thereof and that the sheet was in an excessive dry state and thus caused an image defect on the sheet due to improper transfer or the like.

### SUMMARY OF THE INVENTION

According to an aspect of the present invention, there is provided an image forming apparatus comprising: an image forming portion configured to form an image on a sheet; a detecting portion capable of detecting a light transmittance of the sheet before image formation; and a controller configured to set an initial value of the light transmittance of the sheet before the image formation detected by the detecting portion, wherein when a change amount, from the initial value, of a light transmittance detected after setting of the initial value satisfies a predetermined condition, the controller is capable of executing an operation in a condition changing mode for changing an image forming condition of said image forming portion.

According to another aspect of the present invention, there is provided an image forming apparatus comprising: an image forming portion configured to form an image on a sheet; a detecting portion capable of detecting a light transmittance of the sheet before image formation; and a controller configured to change an image forming condition of the image forming portion when a light transmittance of the sheet changes from a first value to a second value different from the first value by a predetermined amount or more.

According to a further aspect of the present invention, there is provided an image forming apparatus comprising: an image forming portion configured to form an image on a sheet; a detecting portion capable of detecting a light transmittance of the sheet before image formation; an environment detecting portion capable of detecting a temperature and a humidity; and a controller configured to control an image forming condition of the image forming portion so that in a case that the temperature and the humidity which are detected by the environment detecting portion are within a first range, the controller changes the image forming condition when the light transmittance of the sheet changes from a first value to a second value different from the first value by a predetermined amount or more, and in a case that the temperature and the humidity which are detected by the environment detecting portion are within a second range, the controller does not change the image forming condition.

Further features of the present invention will become apparent from the following description of exemplary embodiments with reference to the attached drawings.

### BRIEF DESCRIPTION OF THE DRAWINGS

FIG. 1 is a sectional view showing a schematic structure of an image forming apparatus according to First Embodiment of the present invention.

FIG. 2 is a schematic block diagram showing a control system of the image forming apparatus in First Embodiment.

FIG. 3 is a sectional view showing a schematic structure of a state detecting portion of the image forming apparatus in First Embodiment.

FIG. 4 is a flowchart showing a procedure of a process of setting an initial value of a state value in the image forming apparatus in First Embodiment.

FIG. 5 is a flowchart showing a procedure of a process of an image forming operation in the image forming apparatus in First Embodiment.

FIG. 6 is a flowchart showing a procedure of a process of an image forming operation in an image forming apparatus according to Second Embodiment.

In FIG. 7, each of (a), (b) and (c) is a part of the flowchart of FIG. 6, showing the procedure of the process of the image forming operation in the image forming apparatus in Second Embodiment.

FIG. 8 is a graph showing a relationship among an atmospheric temperature, a relative humidity and an absolute water content.

### DESCRIPTION OF EMBODIMENTS

### First Embodiment

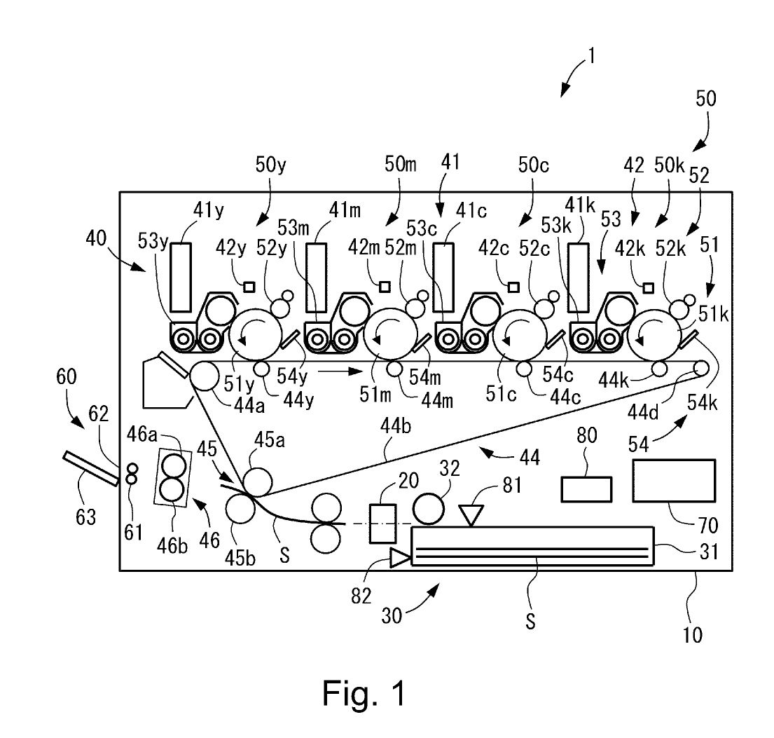

In the following, First Embodiment of the present invention will be specifically described with reference to FIGS. 1-5. In this embodiment, as an example of an image forming apparatus 1, a full-color printed or a tandem type is described. However, the present invention is not limited to the image forming apparatus 1 of the tandem type, but may also be an image forming apparatus of another type. Further, the image forming apparatus 1 is not limited to the full-color image forming apparatus, but may also be a monochromatic image forming apparatus or a single-color image forming apparatus. Or, the image forming apparatus 1 can be carried out in various uses such as printers, various printing machines, copying machines, facsimile machines and multi-function machines. Further, in this embodiment, the image forming apparatus 1 is of a type in which composite toner images of respective colors are primary-transferred from photosensitive drums 51 onto an intermediary transfer belt 44b and thereafter are secondary-transferred altogether onto a sheet S. However, the present invention is not limited thereto, but may also employ a type in which the toner images are directly transferred onto a sheet fed by a sheet feeding belt.

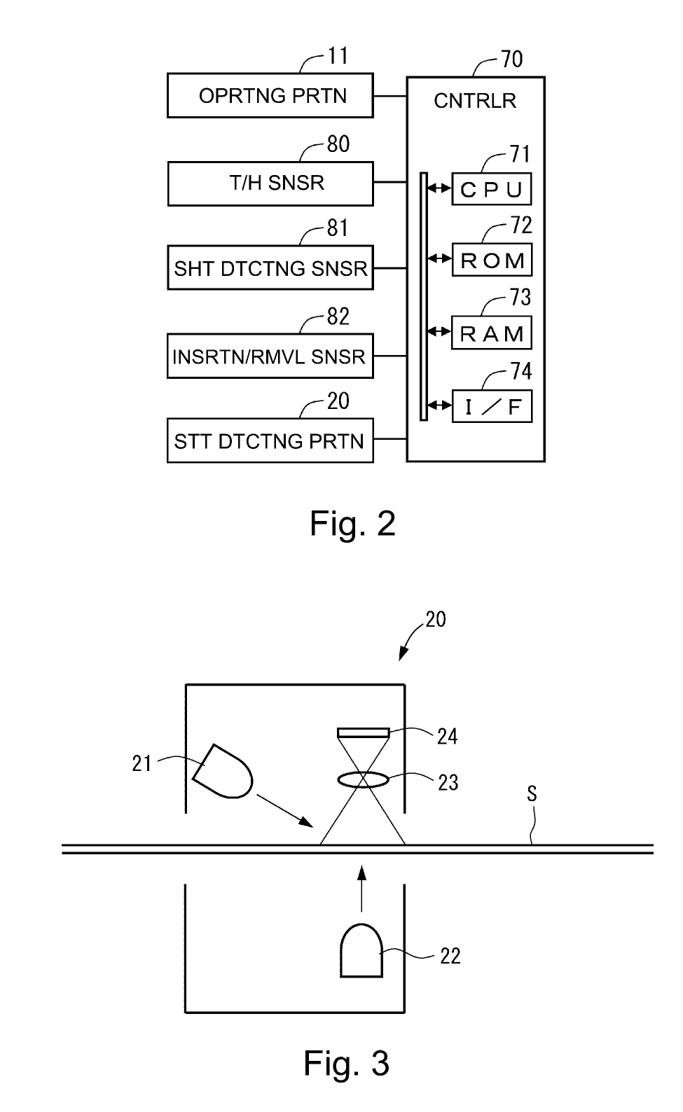

As shown in FIG. 1, the image forming apparatus 1 includes an apparatus main assembly 10, a sheet feeding portion 30, an image forming portion 40, a sheet discharging portion 60, a controller 70 and a state detecting portion 20. The apparatus main assembly 10 is provided with an operating portion 11 (FIG. 2) through which various execution instructions can be inputted by an operation by a user. Further, the apparatus main assembly 10 is provided with a temperature and humidity sensor (environment detecting portion) 80 capable of detecting an inside temperature and an inside humidity of the apparatus main assembly 10. Incidentally, on a sheet S which is a recording material, a toner image is to be formed, and specific examples of the sheet S include plain paper, a synthetic resin sheet as a substitute for the plain paper, thick paper, a sheet for an overhead projector, and the like.

The sheet feeding portion 30 is provided at a lower portion of the apparatus main assembly 10 and includes a sheet cassette (sheet accommodating portion) 31 for stacking and accommodating sheets S to be fed to the image forming portion 40 and a feeding roller 32, and feeds the accommodated sheet S to the image forming portion 40. The sheet feeding portion 30 includes a sheet detecting sensor (exchange detecting portion) 81 and an insertion and removal sensor (exchange detecting portion) 82 in the apparatus main assembly 10 side. The sheet detecting sensor 81 is capable of detecting the presence or absence of the sheet S in the sheet cassette 31, and the insertion and removal sensor 82 is capable of detecting whether or not the sheet cassette 31 is mounted (inserted) in the apparatus main assembly 10. That is, by these sensors 81 and 82, it is possible to detect exchange of the sheet S accommodated in the sheet cassette 31.

The image forming portion 40 includes image forming units 50y, 50m, 50c and 50k, toner bottles 41y, 41m, 41c and 41k, exposure devices 42y, 42m, 42c and 42k, an intermediary transfer unit 44, a secondary transfer portion 45 and a fixing portion 46. The image forming portion 40 is capable of forming the image on the sheet S on the basis of image information. Incidentally, the image forming apparatus 1 in this embodiment is capable of forming a full-color image and includes the image forming units 50y for yellow (y), 50m for magenta (m), 50c for cyan (c) and 50k for black (k), which have the same constitution and which are provided separately. For this reason, in FIG. 1, respective constituent elements for four colors are shown by adding associated color identifiers to associated reference numerals, but in the specification, the constituent elements are described using only the reference numerals without adding the color identifier in some cases.

The image forming unit 50 includes a photosensitive drum 50, a charging roller 52, a developing device 53 and a regulating blade 54.

The photosensitive drum 51 includes a photosensitive layer formed on an outer peripheral surface of an aluminum cylinder so as to have a negative charge polarity and rotates in an arrow direction at a predetermined process speed (peripheral speed). The charging roller 52 contacts the surface of the photosensitive drum 51, so that the surface of the photosensitive drum 51 is electrically charged uniformly. On the surface of the photosensitive drum 51, after charging, an electrostatic image is formed on the basis of image information by the exposure device 42. The photosensitive drum 51 circulates and moves while carrying the formed electrostatic image, and the electrostatic image is developed with toner by the developing device 53.

The toner image formed on the photosensitive drum 51 is primary-transferred onto the intermediary transfer belt 44b described later. The surface of the photosensitive drum 51 after primary transfer is discharged by an unshown pre-exposure portion. The regulating blade 54 is disposed in contact with the surface of the photosensitive drum 51 and removes a residual matter such as toner residual toner remaining on the surface of the photosensitive drum 51 after discharging.

The intermediary transfer unit 44 includes a plurality of rollers including a driving roller 44a, a follower roller 44d and the primary transfer rollers 44y, 44m, 44c and 44k and includes the intermediary transfer belt (image bearing member) 44b wound around these rollers, for carrying the toner images. The primary transfer rollers 44y, 44m, 44c and 44k are disposed opposed to the photosensitive drums 44y, 44m, 44c and 44k, respectively, and contact the intermediary transfer belt 44b.

By applying a positive transfer bias to the intermediary transfer belt 44b through the primary transfer rollers 44y, 44m, 44c and 44k, negative toner images on the photosensitive drums 51y, 51m, 51c and 51k are multiple-transferred successively onto the intermediary transfer belt 44b.

The secondary transfer portion 45 includes an inner secondary transfer roller 45a and an outer secondary transfer roller (transfer means) 45b. By applying a positive secondary transfer bias to the outer secondary transfer roller 45b, the full-color toner image formed on the intermediary transfer belt 44b is transferred onto the sheet S.

The fixing portion 46 includes a fixing roller 46a and a pressing roller 46b. The sheet S is nipped and fed between the fixing roller 46a and the pressing roller 46b, whereby the toner image transferred on the sheet S is heated and pressed and is fixed on the sheet S.

The sheet discharging portion 60 includes a discharging roller pair 61 provided in a downstream side of a discharging path and includes a discharge opening 62 and a discharge tray 63 which are provided at a side portion of the apparatus main assembly 10. The discharging roller pair 61 feeds the sheet S fed from the nip along the discharging path and is capable of discharging the sheet S through the discharge opening 62. The sheet S discharged through the discharge opening 62 is stacked on the discharge tray 63.

As shown in FIG. 2, the controller 70 is constituted by a computer and includes, for example, a CPU 71, a ROM 72 for storing a program for controlling the respective portions, a RAM 73 for temporarily storing data, and an input/output circuit (I/F) 74 through which signals are inputted from and outputted into an external device. The CPU 71 is a microprocessor for managing an entirety of control of the image forming apparatus 1 and is a main body of a system controller. The CPU 71 is connected with the sheet feeding portion 30, the image forming portion 40 and the sheet discharging portion 60 via the input/output circuit 74 and not only transfers signals with the respective portions but also controls operations of the respective portions.

Further, the CPU 71 is connected with the operating portion 11, the temperature and humidity sensor 80, the sheet detecting sensor 81, the insertion and removal sensor 82 and the state detecting portion 20 via the input/output circuit (I/F) 74. The operating portion 11 sets an operating mode of the image forming operation at a moisture absorption sheet countermeasure mode or a dry sheet countermeasure mode by an operation by a user, and is capable of inputting the set mode into the controller 70. In the ROM 72, an image forming control sequence for forming the image on the sheet S, a fixing temperature control sequence and the like of the fixing portion 46 are stored. In the RAM 73, an initial value of the sheet S and the like are stored.

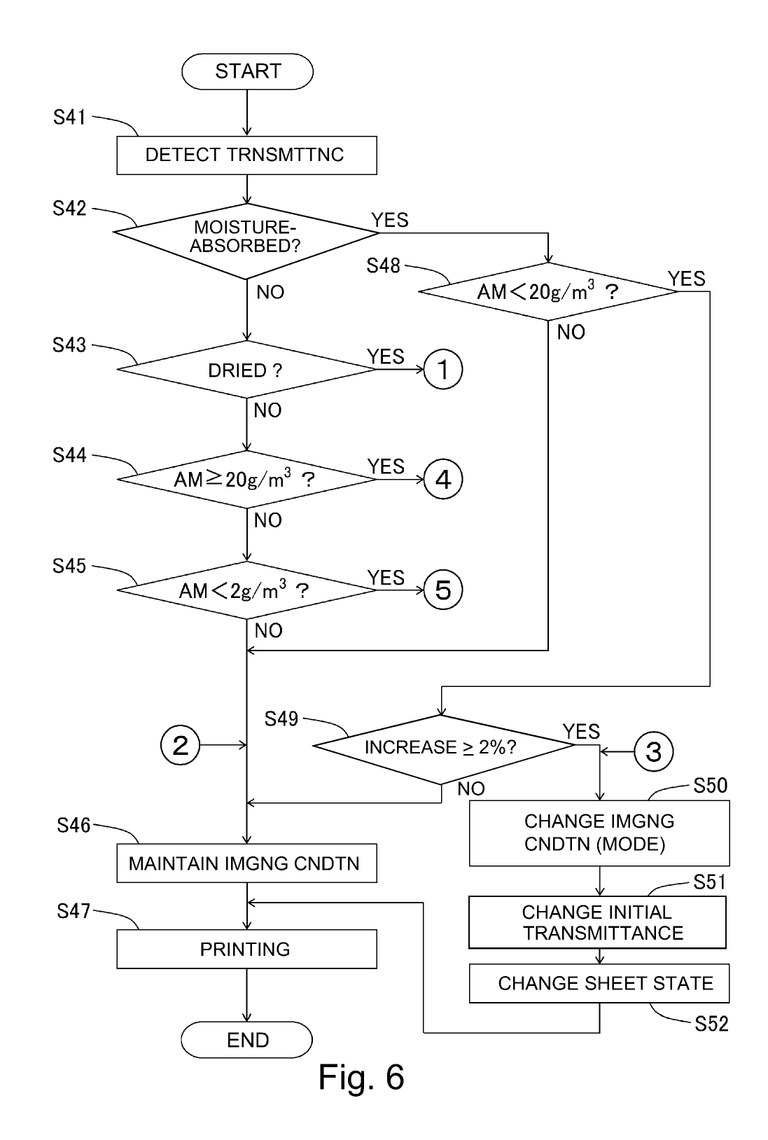

The controller 70 causes the state detecting portion 20 to detect a transmittance of the sheet S before image formation and sets an initial transmittance (initial value) of the sheet S (FIG. 5). In the case where a change amount, to the initial transmittance, of a transmittance detected after setting of the initial transmittance satisfies a predetermined condition (steps S22, S25 and S27), the controller 70 is capable of executing an operation in a condition changing mode (step S23) for changing the image forming condition of the image forming portion 40. The CPU 71 is capable of executing the condition changing mode (step S23) in the case where after setting of the initial transmittance, exchange of the sheet S accommodated in the sheet cassette 31 is not detected by the sheet detecting sensor 81 and the insertion and removal sensor 82 (step S28). Incidentally, the sheet S detected when the initial transmittance is set and the sheet S detected after setting of the initial transmittance are the sheets of the same kind. After setting of the initial transmittance, the controller 70 causes the state detecting portion 20 to detect the transmittance of each of all sheets S before the image formation at the image formation, and executes the operation in the condition changing mode (step S23) in the case where the predetermined condition (steps S22, S25 and S27) is satisfied.

The controller 70 changes the image forming condition of the image forming portion 40 (step S23) in the case where the transmittance of the sheet S changes from a first transmittance to a second transmittance different from the first transmittance by a predetermined amount or more (step S22, S25 and S27). In this case, the first transmittance is the initial transmittance, for example. The predetermined amount is an increase or a decrease of 2%, for example.

Next, the image forming operation of the image forming apparatus 1 constituted as described above will be described.

When the image forming operation is started, first, the photosensitive drum 51 is rotated and the surface thereof is electrically charged by the charging roller 52. Then, on the basis of the image information, the laser light is emitted from the exposure device 42 to the photosensitive drum 51, so that the electrostatic latent image is formed on the surface of the photosensitive drum 51. The toner is deposited on this electrostatic latent image, whereby the electrostatic latent image is developed and visualized as the toner image and then the toner image is transferred onto the intermediary transfer belt 44b.

On the other hand, the feeding roller 32 rotates in parallel to such a toner image forming operation and feeds an uppermost sheet S on the sheet cassette 31 while separating the sheet S. Then, the sheet S is conveyed to the secondary transfer portion 45 along the feeding path by being timed to the toner image on the intermediary transfer belt 44b. Then, the image is transferred from the intermediary transfer belt 44b onto the sheet S. The sheet S is conveyed to the fixing portion 46, in which the unfixed toner image is heated and pressed and thus is fixed on the surface of the sheet S, and then the sheet S is discharged through the discharge opening 62 by the discharging roller pair 61 and is stacked on the discharge tray 63.

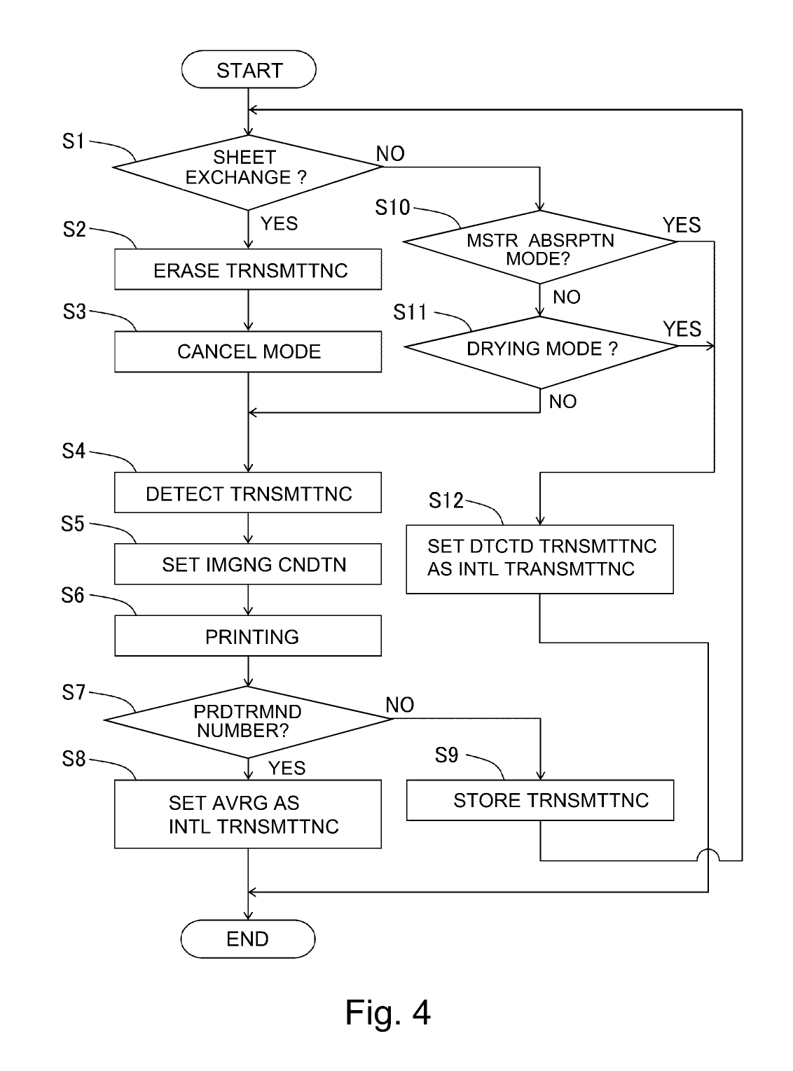

Next, a constitution of the state detecting portion 20 will be described specifically. As shown in FIG. 3. The state detecting portion 20 includes an LRD 21 for reflected light, an LED 22 for transmitted light, an imaging lens 23 and a CMON sensor 24 and is capable of detecting a state value of the sheet S before image formation. Here, the state value of the sheet is, for example, a transmittance (transmission coefficient) or a transmission amount of light, sound wave (ultrasonic wave) or the like through the sheet S. In this embodiment, the state value is the light transmittance. Accordingly, the state detecting portion 20 is a transmittance detecting portion capable of detecting the light transmittance of the sheet S. The transmittance refers to a ratio between an output of the CMON sensor 24 when the sheet S does not exist between the LED 22 for transmitted light and the CMOS sensor 24 and an output of the CMOS sensor 24 when the sheet S exists and the CMOS sensor 24 receives the transmitted light. However, a detected value acquired from the CMOS sensor 24 represents a value of a transmitted light quantity and is referred to as the “transmittance” in this embodiment, but the transmittance is not calculated from the detected value, and the detected value of the transmitted light quantity is used as it is in place of a true transmittance, so that an increase or a decrease of the transmitted light is detected.

The LED 21 for reflected light is a light source for detecting a reflected light quantity and is provided obliquely above an imaging (image pick-up) region on the sheet S. The imaging lens 23 forms an image, in the imaging region on the sheet S, on pixels of the CMOM sensor 24. For this reason, the light emitted from the LED 21 for reflected light is incident on the surface of the sheet S so as to have a predetermined incident angle, and the reflected light from the sheet S is focused through the imaging lens 3, so that the image is formed on the CMOS sensor 24. The controller 70 controls the CMOS sensor 24 and extracts an electric signal proportional to the received light quantity (amount), and thus reads a surface image of the surface S. Accordingly, a reflected image from the surface of the sheet S represents an uneven state in the imaging region. The controller 70 detects a light reflectivity by using this reflected image.

The LED 22 for transmitted light 22 is a light source for detecting the transmitted light quantity of the sheet S and is provided in a side opposite from the CMOS sensor 24 through the sheet S (or the feeding path in the case where there is no sheet S). The light emitted from the LED 22 for transmitted light enters the sheet S from the side opposite from the CMOS sensor 24. The transmitted light through the sheet S is focused through the imaging lens 23 and the image is formed on the CMOS sensor 24. At this time, the transmittance is detected from a luminance value in an entire area or a predetermined range of the CMOS sensor 24.

Here, information required for forming the image on the sheet S is surface smoothness and a weight per unit area (also referred to as a basis weight) of the sheet S. The surface smoothness of the sheet S is acquired from the light reflectivity (or a value representing the reflectivity, specifically a value representing the reflected light quantity) and a relational expression. Further, the weight per unit area or the basis weight is acquired from the transmittance (specifically a value representing the transmitted light quantity) and a relational expression. The transmittance value decreases when the weight per unit area or the basis weight increases, and increases when the weight per unit area or the basis weight decreases. In the case where the quantity (amount) of the light emitted from the light source is determined in advance, the reflectivity (reflectance) calculated from the value representing the reflected light quantity and the transmittance calculated from the value representing the transmitted light quantity are capable of being calculated with accuracy necessary to detect the kind of the sheet S.

Next, a principle of detecting a water-retaining state of the sheet S will be described. First, in a sheet bundle packed as a single package, a weight of the sheets S immediately after unpacked was measured, and an average weight and a variation thereof were calculated. Each of the sheets S was 68 g/m² in basis weight, and the number of measuring sheets was 20 (sheets). A result is shown in Table 1. As shown in Table 1, the variation of the sheet weight in the same (single) package was about 0.9%.

TABLE 1

| AW*¹ (g) | SD*² (g) | Proportion (%) |
|---|---|---|
| 4.45 | 0.04 | 0.9 |

*¹“AW” is the average weight.
*²“SD” is standard deviation.

Further, in a sheet bundle which is of the same kind as the above-described sheet bundle and which is packed as a single package, the sheets immediately unpacked were subjected to measurement of a change with time of a weight with a change in water-retaining state, so that a difference and an increase or a decrease were calculated. Each of the sheets S was 68 g/m² in basis weight, and the number of measuring sheets was 10 (sheets as a bundle). The weights immediately after unpacked and after a lapse of 24 hours were compared with each other. A result is shown in Table 2. As shown in Table 2, the change in weight of the sheet after the lapse of 24 hours relative to the sheet weight immediately after unpacked was an increase of about 4% in the case where the sheet absorbed moisture and was a decrease of about 3% in the case where the sheet was dried. From the results of Tables 1 and 2, a degree of the change in weight with the change in water-maintaining state was larger than a degree of the variation in sheet weight in the same package.

TABLE 2

| | TIAU*¹ (g) | WA24*² (g) | D*³ (g) | I/D*⁴ (%) |
|---|---|---|---|---|
| 15° C./10% | 44.45 | 43.14 | 1.31 | −2.9 |
| 30° C./80% | 44.61 | 46.31 | 1.70 | 3.8 |

*¹“WIAU” is the weight immediately after unpacked.
*²“WA24” is the weight after the lapse of 24 hours.
*³“D” is the difference in weight.
*⁴“I/D” is the increase or the decrease (percentage).

Further, by using the state detecting portion 20 in this embodiment, a detection value of the transmittance with the change in water-retaining state of the sheet S was acquired. The sheet S was 68 g/m² in basis weight, and the weights of the sheet S immediately after unpacked, after a lapse of 24 hours and after a lapse of 48 hours were compared with each other. A result is shown in Table 3.

TABLE 3

| | TLQDV*¹ | | | I/D*² (%) | |
|---|---|---|---|---|---|
| | IAU*³ | A24*⁴ | A48*⁵ | A24*⁴ | A48*⁵ |
| 15° C./10% | 9844 | 9945 | 10233 | 1.0 | 4.0 |
| 30° C./80% | 10479 | 10258 | 10233 | −2.1 | −2.3 |

*¹“TLQDV” is a transmitted light quantity detection value.
*²“I/D” is the increase or the decrease (percentage).
*³“IAU” is the detection value immediately after unpacked.
*⁴“A24” is the detection value after the lapse of 24 hours.
*⁵“A48” is the detection value after the lapse of 48 hours.

As shown in Table, in the case where the state of the sheet S was changed to a moisture absorption state, i.e., in the case where the sheet weight increased, the transmitted light quantity was decreased by about 2%. Further, in the case where the state of the sheet S was changed to a dry state, i.e., in the case where the sheet weight decreased, the transmitted light quantity was increased by about 4%. In this case, comparison is made using the transmitted light quantity, but even when the comparison is made using the transmittance, a similar result is obtained. From Tables 2 and 3, the values of the weight change and the transmitted light quantity (transmittance) between the moisture absorption state and the dry state showed an inverse correlation. Therefore, in this embodiment, a threshold larger than the variation in sheet weight in the same package is set, and detection of the water-retaining state of the sheet S is carried out by the state detecting portion 20 through relative comparison as the whether or not the variation exceeds the threshold.

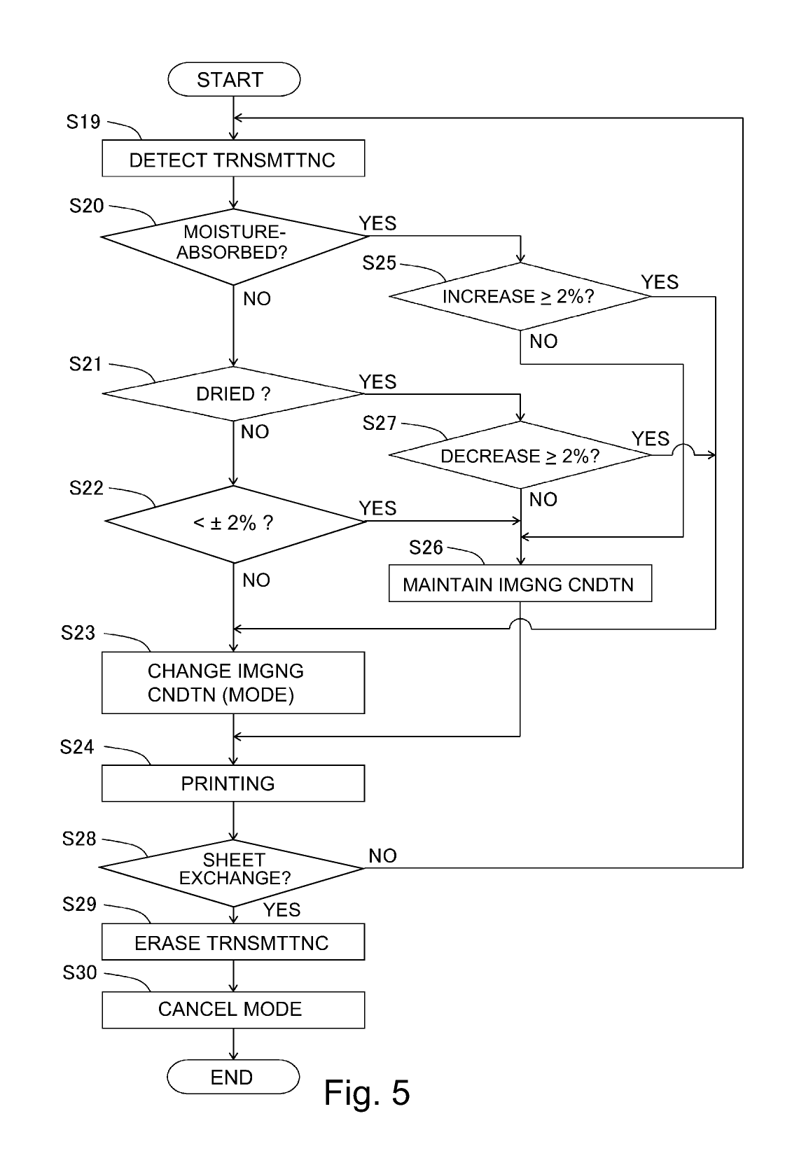

Next, a procedure of executing the image formation in which the image forming condition is set using the above-described image forming apparatus 1 will be described along flowcharts shown in FIGS. 4 and 5.

First, a procedure of determining an initial transmittance as a reference of comparison will be described along the flowchart shown in FIG. 4. When the CPU 71 receives a print start instruction from an unshown computer connected with the image forming apparatus 1, the CPU 71 discriminates whether or not the sheet S accommodated in the sheet cassette 31 is exchanged (changed or supplied) (step S1). The CPU 71 discriminates whether or not the sheet S is exchanged on the basis of a detection result of the sheet detecting sensor 81 and/or the insertion and removal sensor 82.

In the case where the CPU 71 discriminated that the sheet S was exchanged, the CPU 71 treats the sheet S in the sheet cassette 31 as a new sheet S and erases the initial transmittance and a temporary transmittance which have already been stored (step S2). Further, in the case where as an operating mode, a moisture absorption sheet countermeasure mode or a dry sheet countermeasure mode is executed, the CPU 71 cancels the operating mode (step S3). The CPU 71 causes the state detecting portion 20 to detect the transmittance of the sheet S (step S4) and set the image forming condition depending on a detection result (step S5), and then executes printing (step S6).

After the printing, the CPU 71 discriminates whether or not a detected sheet number of the sheets S in the step S4 reaches a predetermined sheet number necessary to determine the initial transmittance (for example, 5 sheets) (step S7). In the case where the CPU 71 discriminated that the detected sheet number of the sheets S in the step S4 reached the predetermined number, the CPU 71 sets an average of transmittance values from the first sheet to the predetermined-numbered sheet as the initial transmittance, and stores the initial transmittance in the RAM 73, for example (step S8), and then ends a setting process.

In the case where the CPU 71 discriminated that the detected sheet number of the sheets S in the step S4 did not reach the predetermined number, the CPU 71 temporarily stores a detection result of the transmittance values corresponding to the detected sheet number in the RMA 73, for example (step S9). Then the CPU 71 repeats the process from the step S1 until the initial transmittance is decided in the step S8.

In this embodiment, the user makes reference to a printing result immediately after the sheet exchange, and for example, in the case where the sheet S causes creases or a curl, the user turns on the moisture absorption sheet countermeasure mode by using the operating portion 11 or the computer connected with the image forming apparatus 1. As a result, the CPU 71 sets the operating mode at the moisture absorption sheet countermeasure mode. Further, the user makes reference to the printing result, and for example, in the case where the sheet S causes improper transfer due to the dry state, the user turns on the dry sheet countermeasure mode by using the operating portion 11 or the computer connected with the image forming apparatus 1. As a result, the CPU 71 sets the operating mode at the dry sheet countermeasure mode.

In the case where the CPU 71 discriminated in the step S1 that the sheet S was not exchanged, the CPU discriminates whether or not the moisture absorption sheet countermeasure mode is turned on (step S10). In the case where the CPU 71 discriminated that the moisture absorption sheet countermeasure mode is not turned on, the CPU 71 discriminates whether or not the dry sheet countermeasure mode is turned on (step S11). In the case where the CPU 71 discriminated that the dry sheet countermeasure mode is not turned on, the CPU 71 discriminates that the sheet S is in an equilibrium state, and executes again the detection of the transmittance of the sheet by the state detecting portion 20 (step S4).

In the case where the CPU 71 discriminated in the step S10 that the moisture absorption sheet countermeasure mode is turned on, the CPU 71 discriminates that the sheet S is in the moisture absorption state. Then, the CPU 71 sets the sheet state at the moisture absorption state and sets the last detected transmittance at the initial transmittance, and then stores the moisture absorption state and the initial transmittance in, for example, the RAM 73 (step S12) and ends the process. In the case where the CPU 71 discriminated in the step S11 that the dry sheet countermeasure mode is turned on, the CPU 71 discriminates that the sheet S is in the dry state. Further, the CPU 71 sets the sheet state at the dry state sets the last detected transmittance at the initial transmittance, and then stores the dry state and the initial transmittance in, for example, the RAM 73 (step S12) and ends the process.

Next, a procedure of executing the image formation by using the set initial transmittance will be described along the flowchart shown in FIG. 5. When the CPU 71 receives the print start instruction from the unshown computer connected with the image forming apparatus 1, the CPU 71 causes a feeding means to feed one sheet S from the sheet cassette 31 and causes the state detecting portion 20 to detect the transmittance of the sheet S (step S19). The sheet S detected when the initial transmittance is set and the sheet S detected after setting of the initial transmittance are the sheets of the same kind since the sheets are not exchanged.

The CPU 71 discriminates whether or not the sheet state during storing of the initial transmittance is the moisture absorption state (step S20). In the case where the CPU 71 discriminated that the sheet state is not the moisture absorption state, the CPU 71 discriminates whether or not the sheet state during storing of the initial transmittance is the dry state (step S21). In the case where the CPU 71 discriminated that the sheet state is not the dry state, the CPU 71 compares the stored initial transmittance (initial value) with the latest detected transmittance and calculates an increase or a decrease between the transmittances, and then discriminates whether or not a comparison result is the increase or the decrease by less than 2% (step S22, predetermined condition). Incidentally, in the case where the comparison result is the increase, the basis weight or the weight decreases, and in the case where the comparison result is the decrease, the basis weight or the weight increases.

In the case where the CPU 71 discriminated that the comparison result is not the increase or the decrease by less than 2%, the CPU 71 changes the image forming condition depending on the comparison result (step S23, condition changing mode). In this embodiment, in the case where the comparison result is the decrease by not less than 2%, the CPU 71 discriminates that the state of the sheet S is the moisture absorption state and sets the moisture absorption sheet countermeasure mode correspondingly to the sheet kind. As control of the image forming condition in the operation in the moisture absorption sheet countermeasure mode, for example, it is possible to employ control such that a control fixing temperature, a process speed, a secondary transfer bias or the like is decreased.

Further, in the case where the comparison result is the increase by not less than 2%, the CPU 71 discriminates that the state of the sheet S is the dry state and sets the dry sheet countermeasure mode correspondingly to the sheet kind. As control of the image forming condition in the operation in the dry sheet countermeasure mode, for example, it is possible to employ control such that the secondary transfer bias or the like is increased. The CPU 71 executes the printing after each of the countermeasure modes is set (step S24).

On the other hand, in the step S20, in the case where the CPU 71 discriminated that the sheet state during storing of the initial transmittance is the moisture absorption state, the CPU 71 compares the stored initial transmittance (initial value) with the latest detected transmittance and calculates an increase or a decrease between the transmittances. Then, the CPU 71 discriminates whether or not the comparison result is the increase by not less than 2% (step S25, predetermined condition). In the case where the CPU 71 discriminated that the comparison result is the increase by not less than 2%, the CPU 71 discriminates that the sheet S is not in the moisture absorption state. In the case where the increase amount is not less than 2% and less than 6%, the CPU 71 discriminates that the sheet S is in the equilibrium state which is neither the moisture absorption state nor the dry state, and cancels the moisture absorption sheet countermeasure mode and then sets the image forming condition correspondingly to the sheet kind (step S23). Further, in the case where the increase amount is not less than 6%, the CPU 71 discriminates that the sheet S is in the dry state and sets the countermeasure mode at the dry sheet countermeasure mode correspondingly to the sheet kind (step S23).

In the case where the CPU 71 discriminated in the step S25 that the comparison result is not the increase by not less than 2%, the CPU 71 discriminates that the sheet S is kept in the moisture absorption state and maintains the image forming condition without changing the image forming condition (step S26). The CPU 71 causes the image forming apparatus to carry out the printing in the operation in the moisture absorption sheet countermeasure mode correspondingly to the sheet kind (step S24).

In the case where the CPU 71 discriminated in the step S21 that the sheet state during storing of the initial transmittance is the dry state, the CPU 71 compares the stored initial transmittance (initial value) with the latest detected transmittance and calculates an increase or a decrease. Then, the CPU 71 discriminates whether or not the comparison result is the decrease by not less than 2% (step S27, predetermined condition). In the case where the CPU 71 discriminated that the comparison result is the decrease by not less than 2%, the CPU discriminates that the sheet S is not in the dry state. In the case where the decrease amount is not less than 2% and less than 6%, the CPU 71 discriminates that the sheet S is in the equilibrium state which is neither the dry state nor the dry state, and cancels the moisture absorption sheet countermeasure mode and then sets the image forming condition correspondingly to the sheet kind (step S23). Further, in the case where the decrease amount is not less than 6%, the CPU 71 discriminates that the sheet S is in the moisture absorption state and sets the countermeasure mode at the moisture absorption sheet countermeasure mode correspondingly to the sheet kind (step S23).

In the case where the CPU 71 discriminated in the step S27 that the comparison result is not the decrease by not less than 2%, the CPU 71 discriminates that the sheet S is kept in the dry state and maintains the image forming condition without changing the image forming condition (step S26). The CPU 71 causes the image forming apparatus to carry out the printing in the operation in the dry sheet countermeasure mode correspondingly to the sheet kind (step S24). Further, in the case where the CPU 71 discriminated in the step S22 that the comparison result is the increase or the decrease by less than 2%, the CPU 71 discriminates that the sheet S is in the equilibrium state which is neither the moisture absorption state nor the dry state. Then, the CPU 71 maintains the image forming condition without changing the image forming condition (step S26) and carries out the printing under the image forming condition corresponding to the sheet kind (step S24).

After the printing, the CPU 71 discriminates whether or not the sheet S is exchanged (step S28). In the case where the CPU 71 discriminated that the sheet S is not exchanged, the CPU 71 detects the transmittance of a subsequent sheet S (step S19) and repeats the above-described comparison and change in control. That is, the CPU 71 repeats the above-described comparison and change in control until the sheet S in the sheet cassette 31 is exchanged. In other words, the CPU 71 executes the operation in the condition changing mode for all of the sheets S after setting of the initial transmittance and before image formation at the image forming portion 40. In the case where the CPU 71 discriminated that the sheet S is executed in the step S28, the CPU 71 erases the initial transmittance (step S29) and cancels the countermeasure mode in the case where the moisture absorption sheet countermeasure mode or the dry sheet countermeasure mode is set by the user (step S30), and then ends the process.

Incidentally, the threshold of the transmittance for discriminating the above-described states is an example and may also be appropriately changed depending on detection accuracy of the state detecting portion 20, the kind of the sheet S or the like.

As described above, according to the image forming apparatus 1 in this embodiment, the controller 70 not only sets the initial value of the transmittance of the sheet S but also is capable of executing the operation in the condition changing mode for changing the image forming condition in the case where the change amount to the initial value of the transmittance of the sheet S satisfies the predetermined condition. For this reason, depending on the water-retaining state of the sheet, the image forming condition can be satisfactorily controlled.

Further, according to the image forming apparatus 1 in this embodiment, after setting of the initial transmittance, the controller 70 detects the transmittance of the sheet S of all of the sheets S before the image formation at the image forming portion 40. Then, the controller 70 executes the operation in the condition changing mode in the case where each of the transmittances satisfies the associated predetermined condition (step S22, S25 or S27). For this reason, the transmittance of the sheet S can be detected one by one, so that the change in transmittance of the sheet S can be specifically detected.

In the above-described image forming apparatus 1 in this embodiment, the case where not only the sheet kind detection was made for all of the sheets S by the controller but also the detection result was fed back to the image forming condition was described, but the present invention is not limited thereto. For example, the sheet kind is detected for the first sheet S or the predetermined numbered sheet S, and by using a detected value at the time, the image forming condition may also be determined.

### Second Embodiment

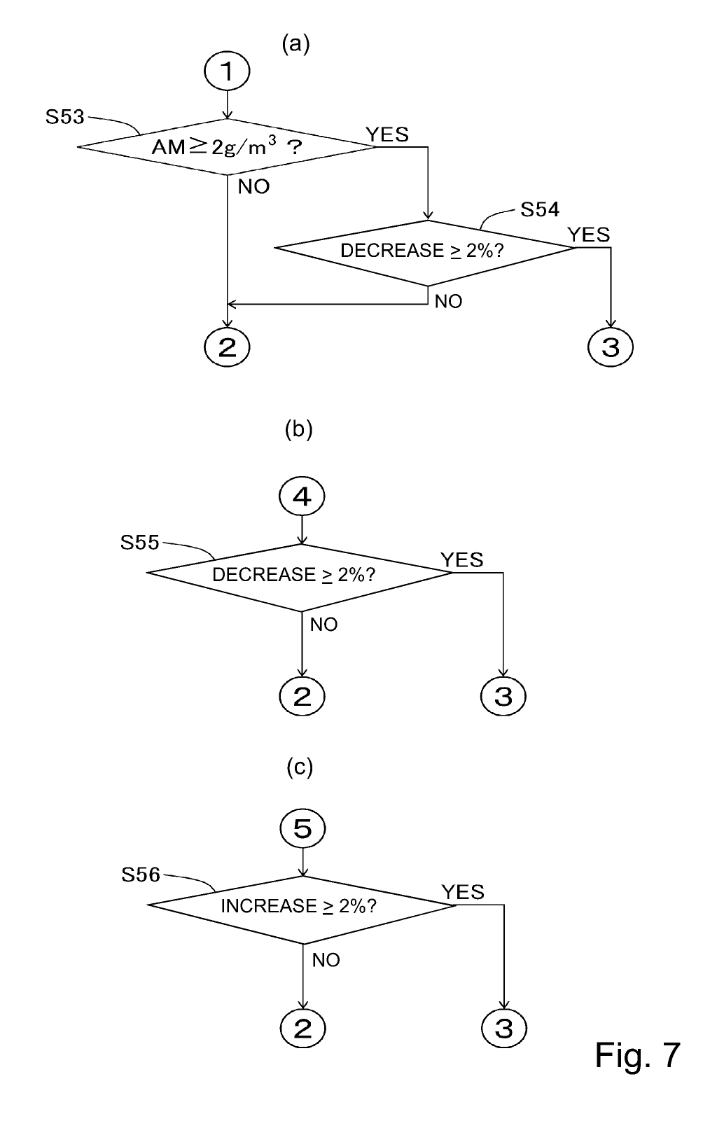

Next, Second Embodiment of the present invention will be specifically described with reference to FIGS. 6-8. In this embodiment, a constitution is different from that in First Embodiment in that the operation in the condition changing mode is carried out in the case where the temperature and humidity detected by using the temperature and humidity sensor 80 are within a predetermined range. However, other constitutes are similar to those in First Embodiment, and therefore, elements of the constitutions are represented by the same reference numerals or symbols and will be omitted from detailed description.

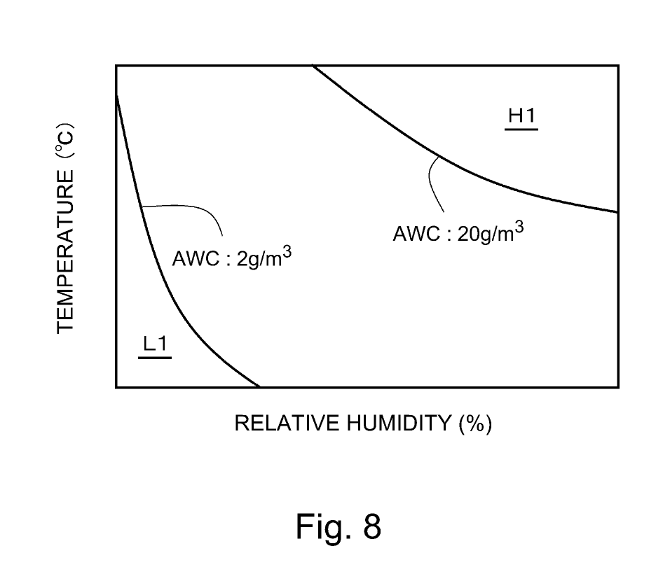

In this embodiment, the controller 70 executes the operation in the condition changing mode in the case where the temperature and humidity detected by the temperature and humidity sensor (environment detecting portion) 80 are within the predetermined range. A relationship of an absolute water content with a relative humidity and a temperature is shown in FIG. 8. In this embodiment, a region in which the relative humidity and the temperature are high, e.g., the absolute water content is not less than 20 g/m³ is a moisture absorption region H1, and a region in which the relative humidity and the temperature are low, e.g., the absolute water content is less than 20 g/m³ is a dry region L1.

In this embodiment, the controller 70 sets the image forming condition in the following manner, for example.

First, the temperature and humidity detected by the temperature and humidity sensor 80 are within a first range, the CPU 71 changes the image forming condition of the image forming portion 40 (step S23) in the case where the transmittance of the sheet S changes from a first transmittance to a second transmittance different from the first transmittance by a predetermined amount or more. Further, the CPU 71 does not change the image forming condition when the temperature and humidity detected by the temperature and humidity sensor 80 is within a second range. In this embodiment, the first range is a combination of the temperature and humidity providing the absolute water content (AM) of, e.g., less than 2 g/m³ and 20 g/m³ or more (FIG. 8). Further, the second range is a combination of the temperature and humidity providing the absolute water content (AM) of, e.g., 2 g/m³ or more and less than 20 g/m³ (FIG. 8). Further, the first transmittance is the initial transmittance, for example. The predetermined amount is an increase or a decrease of 2%, for example.

A procedure of executing the image formation in which the image forming condition is set using the above-described image forming apparatus 1 will be described along a flowchart shown in FIGS. 6 and 7, in which a single flowchart is divided into two portions shown in FIGS. 6 and 7.

A procedure of determining an initial transmittance as a reference of comparison is similar to that in the flowchart shown in FIG. 4 in First Embodiment. After the initial transmittance is set, when the CPU 71 receives the print start instruction from the unshown computer connected with the image forming apparatus 1, the CPU 71 causes a feeding means to feed one sheet S from the sheet cassette 31 and causes the state detecting portion 20 to detect the transmittance of the sheet S (step S41). The sheet S detected when the initial transmittance is set and the sheet S detected after setting of the initial transmittance are the sheets of the same kind since the sheets are not exchanged.

The CPU 71 discriminates whether or not the sheet state during storing of the initial transmittance is the moisture absorption state (step S42). In the case where the CPU 71 discriminated that the sheet state is not the moisture absorption state, the CPU 71 discriminates whether or not the sheet state during storing of the initial transmittance is the dry state (step S43). In the case where the CPU 71 discriminated that the sheet state is not the dry state, the CPU 71 discriminates whether or not the absolute water content (AM) is 20 g/m³ or more, i.e., whether or not the absolute water content (AM) is in the moisture absorption region H1 by making reference to a detection result of the temperature and humidity sensor 80 (step S44). In the case where the CPU 71 discriminated that the absolute water content (AM) is not 20 g/m³ or more, the CPU 71 discriminates whether or not the absolute water content (AM) is less than 2 g/m³, i.e., whether or not the absolute water content (AM) is in the dry region L1 by making reference to the detection result of the temperature and humidity sensor 80 (step S45). In the case where the CPU 71 discriminated that the absolute water content (AM) is not less than 2 g/m³, the CPU 71 discriminates that the sheet S is kept in the equilibrium state which is neither the moisture absorption state nor the dry state, and maintains the image forming condition without changing the image forming condition (step 46), and then carries out the printing under the image forming condition corresponding to the sheet kind (step S47).

In the case where the CPU 71 discriminated in the step S42 that the sheet state is in the moisture absorption state, the CPU 71 discriminates whether or not the absolute water content (AM) is less than 20 g/m³ by making reference to the detection result of the temperature and humidity sensor 80 (step S48). In the case where the CPU 71 discriminated that the absolute water content (AM) is not less than 20 g/m³, the CPU 71 discriminates that the sheet S is kept in the moisture absorption state without being dried. Then, the CPU 71 maintains the image forming condition without changing the image forming condition (step S46) and carries out the printing in the operation in the moisture absorption sheet countermeasure mode correspondingly to the sheet kind which has been decided (step S47).

In the case where the CPU 71 discriminated that the absolute water content (AM) is less than 20 g/m³, the CPU 71 discriminates that there is a possibility that the sheet S is dried and is not in the moisture absorption state. Further, the CPU 71 compares the stored initial transmittance (initial value) with the latest detected transmittance and calculates an increase or a decrease between the transmittances, and then discriminates whether or not a comparison result is the increase by not less than 2% (step S49, predetermined condition). In the case where the CPU 71 discriminated that the comparison result is not the increase by not less than 2%, the CPU 71 discriminates that the sheet S is kept in the moisture absorption state. Then, the CPU 71 maintains the image forming condition without changing the image forming condition (step S46) and carries out the printing in the operation in the moisture absorption sheet countermeasure mode correspondingly to the sheet kind which has been decided (step S47).

In the case where the CPU 71 discriminated that the comparison result is the increase by not less than 2%, the CPU 71 discriminates that the sheet S is not in the moisture absorption state. In the case where the increase amount is not less than 2% and less than 6%, the CPU 71 discriminates that the sheet S is in the equilibrium state which is neither the moisture absorption state nor the dry state, and changes the image forming condition and cancels the moisture absorption sheet countermeasure mode (step S50, condition changing mode). The CPU 71 stores, as the initial transmittance, the transmittance of the sheet detection result by overwriting in, e.g., the RAM 73 (step S51) and deletes the moisture absorption state as the sheet state from the RAM 73 and then sets the sheet state at the equilibrium state (step S52). Further, the CPU 71 carries out the printing under the image forming condition corresponding to the sheet kind which has been decided (step S47). On the other hand, in the case where the increase amount is not less than 6%, the CPU 71 discriminates that the sheet S is in the dry state, and changes the image forming condition and sets the countermeasure mode at the dry sheet countermeasure mode (step S50). The CPU 71 stores, as the initial transmittance, the transmittance of the sheet detection result by overwriting in, e.g., the RAM 73 (step S51) and stores the dry state as the sheet state in the RAM 73 by overwriting (step S52). Further, the CPU 71 carries out the printing in the operation in dry sheet countermeasure mode the corresponding to the sheet kind which has been decided (step S47).

In the case where the CPU 71 discriminated in the step S43 that the sheet state is in the dry state, the CPU 71 discriminates whether or not the absolute water content (AM) is 2 g/m³ or more by making reference to the detection result of the temperature and humidity sensor 80 (step S53). In the case where the CPU 71 discriminated that the absolute water content (AM) is not 2 g/m³ or more, the CPU 71 discriminates that the sheet S is kept in the dry state without absorbing moisture. Then, the CPU 71 maintains the image forming condition without changing the image forming condition (step S46) and carries out the printing in the operation in the dry sheet countermeasure mode correspondingly to the sheet kind which has been decided (step S47).

In the case where the CPU 71 discriminated that the absolute water content (AM) is 2 g/m³ or more, the CPU 71 discriminates that there is a possibility that the sheet S absorbs moisture and is not in the dry state. Further, the CPU 71 compares the stored initial transmittance (initial value) with the latest detected transmittance and calculates an increase or a decrease between the transmittances, and then discriminates whether or not a comparison result is the decrease by not less than 2% (step S54, predetermined condition). In the case where the CPU 71 discriminated that the comparison result is not the decrease by not less than 2%, the CPU 71 discriminates that the sheet S is kept in the dry state. Then, the CPU 71 maintains the image forming condition without changing the image forming condition (step S46) and carries out the printing in the operation in the dry sheet countermeasure mode correspondingly to the sheet kind which has been decided (step S47).

In the case where the CPU 71 discriminated that the comparison result is the decrease by not less than 2%, the CPU 71 discriminates that the sheet S is not in the dry state. In the case where the decrease amount is not less than 2% and less than 6%, the CPU 71 discriminates that the sheet S is in the equilibrium state which is neither the moisture absorption state nor the dry state, and changes the image forming condition and cancels the dry sheet countermeasure mode (step S50). The CPU 71 stores, as the initial transmittance, the transmittance of the sheet detection result by overwriting in, e.g., the RAM 73 (step S51) and deletes the dry state as the sheet state from the RAM 73 and then sets the sheet state at the equilibrium state (step S52). Further, the CPU 71 carries out the printing under the image forming condition corresponding to the sheet kind which has been decided (step S47). On the other hand, in the case where the decrease amount is not less than 6%, the CPU 71 discriminates that the sheet S is in the moisture absorption state, and changes the image forming condition and sets the countermeasure mode at the moisture absorption sheet countermeasure mode (step S50). The CPU 71 stores, as the initial transmittance, the transmittance of the sheet detection result by overwriting in, e.g., the RAM 73 (step S51) and stores the moisture absorption state as the sheet state in the RAM 73 by overwriting (step S52). Further, the CPU 71 carries out the printing in the operation in moisture absorption sheet countermeasure mode the corresponding to the sheet kind which has been decided (step S47).

In the case where the CPU 71 discriminated in the step S44 that the absolute water content (AM) is 20 g/m³ or more, the CPU 71 discriminates that there is a possibility that the sheet S is in the moisture absorption state. Further, the CPU 71 compares the stored initial transmittance (initial value) with the latest detected transmittance and calculates an increase or a decrease between the transmittances, and then discriminates whether or not a comparison result is the decrease by not less than 2% (step S55, predetermined condition). In the case where the CPU 71 discriminated that the comparison result is not the decrease by not less than 2%, the CPU 71 discriminates that the sheet S is kept in the equilibrium state. Then, the CPU 71 maintains the image forming condition without changing the image forming condition (step S46) and carries out the printing under the image forming condition correspondingly to the sheet kind which has been decided (step S47).

In the case where the CPU 71 discriminated that the comparison result is decrease by not less than 2%, the CPU 71 discriminates that the sheet S is in the moisture absorption state, and changes the image forming condition and sets the countermeasure mode at the moisture absorption sheet countermeasure mode (step S50). The CPU 71 stores, as the initial transmittance, the transmittance of the sheet detection result by overwriting in, e.g., the RAM 73 (step S51) and stores the moisture absorption state as the sheet state in the RAM 73 by overwriting (step S52). Further, the CPU 71 carries out the printing in the operation in moisture absorption sheet countermeasure mode the corresponding to the sheet kind which has been decided (step S47).

In the case where the CPU 71 discriminated in the step S45 that the absolute water content (AM) is less than 2 g/m³, the CPU 71 discriminates that there is a possibility that the sheet S is in the dry state. Further, the CPU 71 compares the stored initial transmittance (initial value) with the latest detected transmittance and calculates an increase or a decrease between the transmittances, and then discriminates whether or not a comparison result is the increase by not less than 2% (step S56, predetermined condition). In the case where the CPU 71 discriminated that the comparison result is not the increase by not less than 2%, the CPU 71 discriminates that the sheet S is kept in the equilibrium state. Then, the CPU 71 maintains the image forming condition without changing the image forming condition (step S46) and carries out the printing under the image forming condition correspondingly to the sheet kind which has been decided (step S47).

In the case where the CPU 71 discriminated that the comparison result is increase by not less than 2%, the CPU 71 discriminates that the sheet S is in the dry state, and changes the image forming condition and sets the countermeasure mode at the moisture absorption sheet countermeasure mode (step S50). The CPU 71 stores, as the initial transmittance, the transmittance of the sheet detection result by overwriting in, e.g., the RAM 73 (step S51) and stores the dry state as the sheet state in the RAM 73 by overwriting (step S52). Further, the CPU 71 carries out the printing in the operation in dry sheet countermeasure mode the corresponding to the sheet kind which has been decided (step S47).

As described above, also by the image forming apparatus 1 in this embodiment, the controller 70 not only sets the initial value of the transmittance of the sheet S but also is capable of executing the operation in the condition changing mode for changing the image forming condition in the case where the change amount to the initial value of the transmittance of the sheet S satisfies the predetermined condition. For this reason, depending on the water-retaining state of the sheet, the image forming condition can be satisfactorily controlled.

Further, according to the image forming apparatus 1 in this embodiment, the controller 70 executes the operation in the condition changing mode in the case where the temperature and humidity detected by the temperature and humidity sensor 80 are within the predetermined range. For this reason, compared with the case where all of the sheets subjected to the image formation are subjected to the detection of the transmittance, a frequency of the detection of the transmittance can be reduced, so that lifetime extension of the state detecting portion 20 can be realized.

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

This application claims the benefit of Japanese Patent Application No. 2016-129078 filed on Jun. 29, 2016, which is hereby incorporated by reference herein in its entirety.

What is claimed is:

1. An image forming apparatus comprising:
an image forming portion configured to form an image on a sheet;
a detecting portion capable of detecting a light transmittance of the sheet before image formation; and
a controller configured to set an initial value of the light transmittance of the sheet before the image formation detected by said detecting portion, wherein when a change amount, from the initial value, of a light transmittance detected after setting of the initial value satisfies a predetermined condition, said controller is capable of executing an operation in a condition changing mode for changing an image forming condition of said image forming portion.

2. An image forming apparatus according to claim 1, further comprising:
a sheet accommodating portion configured to accommodate the sheet fed to said image forming portion; and
an exchange detecting portion capable of detecting exchange of the sheet accommodated in said humidity accommodating portion,
wherein said controller is capable of executing the operation in the condition changing mode when the exchange of the sheet accommodated in said sheet accommodating portion is not detected after setting of the initial value.

3. An image forming apparatus according to claim 1, wherein the sheet detected when the initial value is set and the sheet detected after setting of the initial value are the sheets of the same kind.

4. An image forming apparatus according to claim 1, wherein said controller causes said detecting portion to detect the light transmittance of all of sheets subjected to the image formation at said image forming portion after setting of the initial value and executes the operation in the condition changing mode when a change amount of the detected light transmittance of the sheet satisfies the predetermined condition.

5. An image forming apparatus according to claim 1, further comprising an environment detecting portion capable of detecting a temperature and a humidity,
wherein said controller executes the operation in the condition changing mode when the toner and the humidity which are detected by said environment detecting portion are within a predetermined range.

6. An image forming apparatus according to claim 1, wherein said image forming portion includes an image bearing member configured to bear a toner image and transfer means configured to transfer the toner image from said image bearing member onto the sheet by being supplied with a transfer bias,
wherein said controller controls the transfer bias as the image forming condition in the operation in the condition changing mode.

7. An image forming apparatus comprising:
an image forming portion configured to form an image on a sheet;
a detecting portion capable of detecting a light transmittance of the sheet before image formation; and
a controller configured to change an image forming condition of said image forming portion when a light transmittance of the sheet changes from a first value to a second value different from the first value by a predetermined amount or more.

8. An image forming apparatus comprising:
an image forming portion configured to form an image on a sheet;
a detecting portion capable of detecting a light transmittance of the sheet before image formation;
an environment detecting portion capable of detecting a temperature and a humidity; and
a controller configured to control an image forming condition of said image forming portion so that
in a case that the temperature and the humidity which are detected by said environment detecting portion are within a first range, said controller changes the image forming condition when the light transmittance of the sheet changes from a first value to a second value different from the first value by a predetermined amount or more, and
in a case that the temperature and the humidity which are detected by said environment detecting portion are within a second range, said controller does not change the image forming condition.
